(19) United States
(12) Patent Application Publication
(10) Pub. No.: US 2006/0143970 A1
(43) Pub. Date: Jul. 6, 2006

(54) Stake for a decoy

(76) Inventor: Glenn Lindaman, Whitehall, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/325,099

(22) Filed: Jan. 4, 2006

Related U.S. Application Data
(60) Provisional application No. 60/641,295, filed on Jan. 4, 2005.

(51) Int. Cl. A01M 31/06

(52) U.S. Cl. 43/2; 43/3

(57) ABSTRACT

A hunting decoy is structured for lifelike motion in the field by way of a flexible and limited rotational portion provided in a stake assembly that permits the decoy body to move relative to its resting position when force is applied to the decoy, such as through wind. A variety of mounts are provided to secure the stake assembly to the body of the decoy through springs, flanges, eccentric protrusions and fasteners.

### CROSS REFERENCE TO RELATED APPLICATION

This application claims priority of U.S. provisional patent application Ser. No. 60/641,295, filed Jan. 4, 2005.

### FIELD OF THE INVENTION

The invention of this application concerns improved bird hunting decoys and supports for deployed decoys, and more particularly, to a decoy support structure that produces better movement and presentation of the decoy. A hunting decoy according to the present invention, for example, can be shaped and colored to represent a wild turkey. However, the invention of this application has much broader applications and should not be limited to hunting decoys.

The invention of this application relates to animal figurines that can be used as hunting decoys. Lindaman U.S. Pat. Nos. 6,216,382 and 6,481,147 disclose hunting decoys including a hollow decoy structure and a support stake structure and are hereby incorporated by reference for showing the same. Samaras U.S. Pat. No. 6,092,322 discloses a decoy with moving body parts and is also incorporated by reference herein for showing the same. Johnson U.S. Pat. No. 5,515,637 discloses a decoy in which the decoy body is mounted on a vertical stake and is also incorporated by reference herein for showing the same. Sroka U.S. Pat. No. 5,570,531 describes a bird decoy with motion associated with the decoy's head and neck and is also incorporated by reference herein for showing the same. Medved U.S. Pat. No. 5,865,075 describes a locking configuration with an integral fastener and is also incorporated by reference herein for showing the same.

### BACKGROUND

Decoys are known in various shapes and colors to resemble specific animals, a familiar example being game birds. The decoys may be attractive to the corresponding species of game animal or to a different species, as a result of various instincts. These include (for example) social herding or similar safety-in-numbers instincts, predation or other expectation of finding food, opportunities for procreation, the urge to maintain territorial exclusivity, establishment of a place in a hierarchical pecking order, etc.

A decoy advantageously resembles a particular species accurately, at least as to attributes that a target species is inclined to notice. The decoy may be quite realistic, or may simply have critical attributes in common with the particular species it emulates, such as a comparable silhouette, color, movement, sound, odor, etc.

Decoys that appear realistic to humans are more popular among hunters than those that are obviously artificial. The target species may be prone to respond, positively or negatively, to the same aspects as humans, or possibly other aspects. Visually, many animals are highly sensitive to motion.

Visual mimicry is an important consideration, but not the only one. Decoys should be inexpensive to manufacture. The decoy should be compact or subject to packing in a manner that permits a hunter to carry a number of decoys into the field. The decoys should individually be very easy to deploy, quickly and silently, in any terrain that may be encountered, such as open grassland, woods or scrub vegetation.

U.S. Pat. No. 5,570,531 describes a bird decoy with motion associated with the head and neck. The decoy body is stationary. A one-piece head-and-neck portion is mounted to the body so that the head and neck may tilt when sufficient wind prevails. The decoy is helpful in that it moves, but it is not representative of a live animal, whose motion is unlikely to involve displacement of an integrally rigid head and neck relative to a rigid stationary body, even when the animal is standing in place.

U.S. Pat. No. 5,515,637 discloses a decoy in which the decoy body is mounted on a vertical journal axis by bearings. The idea is for ambient breeze to rotate the body on the vertical journal axis without substantial frictional resistance. The journal axis is set precisely vertical. The weight of the decoy is balanced evenly on opposite sides of the axis. The mounting comprises a helical spring which enables the breeze to wobble the decoy in the incident direction of the breeze. However, the pivot point of the device is not optional.

In a frictionless rotational mounting of such a type, it is also possible that the decoy body may turn one way or the other on the vertical axis, due to wind or another impetus. Turning on a vertical axis may appear natural in some conditions and therefore could be interesting to a game animal. However the wind speed and direction must catch the decoy body just right. If the wind is not at the particular speed and oriented in the specific direction that produces a convincing motion, the motion may be such that the decoy is caused to appear as an obvious fake. This problem is acute if there are several decoys deployed in a group. It might appear natural and interesting, for example, for decoys in a group occasionally to face in a new direction, for example as live animals in a group might face in unison toward the source of a sound. If decoys in a group rotate freely, a gust of wind could cause them to rotate in different directions and to continue beyond a full revolution. Such motion is mechanical and unrealistic.

If the rotation axis of a journal mounting is not at the center of mass, and the rotation axis is tilted relative to vertical, the decoy body will rotate preferentially to a stable rotational position at which the heaviest part of the decoy is at the lowest elevation. A gust of wind may act to rotate the body due to differences in surface area, for example exerting greater pressure on the thicker tail section than the thinner head section, causing a rotational force. This may rotationally displace the heaviest part of the decoy body from the angular position at which the heaviest part is at the lowest possible elevation. When the wind force subsides, the body tends to rotate back to the preferred orientation, because the heaviest part of the decoy body settles back at the preferred lowermost elevation. Typically, there is an associated rotational oscillation of a decreasing amplitude around the preferred rotational orientation, as the body settles back to the preferred orientation.

When deploying several decoys, particularly in a situation in which the decoys must be placed quickly and quietly before the hunter is spotted by the game, the hunter cannot take time to test and adjust the verticality of the rotation axes and the balance of the decoy bodies so as to face all the decoys in parallel or nearly parallel directions. Some of the ground stakes are likely to be set more near to vertical than others, which causes certain decoys in a group to be prone to rotate in the wind, while others do not. Even if care has been taken and the decoy bodies are all faced in parallel, balanced and aligned on vertical rotation axes, they may respond to a gust of wind by spinning around 360 degrees or more, possibly in different rotational directions, and may look obviously artificial.

A game animal is sensitive to motion and expects to see realistic motion in live animals. Suspicious unrealistic motion detracts from the effectiveness of the decoy. A group of decoy bodies that spin on their axes in a relatively uncontrolled and mechanical way, facing in random directions at any given time, and possibly spinning through more than 180 or even 360 degrees, is suspicious even if the static shape and color of the decoys are highly realistic.

### SUMMARY OF THE INVENTION

The present invention is applicable generally to visual decoys that are intended to approximate the appearance of a particular species. The decoys may represent any species and/or gender to which animals instinctively respond. A particularly demanding subject as well as a good demonstrative example is the American wild turkey.

Wild turkeys are wary animals with acute senses. Male turkeys are territorial and will challenge another male turkey in an established geographical range. Turkeys of either gender may approach other turkeys to establish dominance in a pecking order. Turkeys are large birds but they can fly a substantial distance and thus can very quickly move about in response to situations.

The invention is, therefore, described with reference to wild turkeys. However, the invention is also applicable to other particular species. For example, the invention can be applied to decoys representing animals that frequent dry land or water, mammals or birds, prey animals or predators, etc. Further, the invention of this application can be used in connection with predator animals to prevent damage from unwanted wildlife or any other use associated with simulating wildlife.

In accordance with the present invention, a decoy support is provided which advantageously produces lifelike motion and which can be quickly adjusted to varied heights.

Further, the stake according to the present invention can include multiple points of movement simulating the movement of the particular animal without producing unlimited movement. Moreover, the decoy according to the present invention is easy to deploy and can be made to be compact for transporting several decoys. More particularly, the decoy in accordance with the present invention can include separate spring mounts between the body structure and the head structure to allow the body and the head to move relative to one another and minimize the likelihood of the decoy being out of balance.

In accordance with another aspect of the present invention, provided is a support structure that also allows the decoy to rotate about a vertical axis to create yet another degree of movement.

In accordance with a further aspect of the present invention, provided is a damping mechanism to help restrict the movement of the decoy body and the decoy head. The damping device can be, for example, a rubber or polymer sleeve coaxial to and covering the spring mechanisms. In another embodiment, the damping or homing of the moving parts relative to the other components can be achieved by the shaped relationship between the moving parts such as by detents in one or more of the components of the movement joints.

In accordance with even yet another aspect of the present invention, the degree of rotation of the decoy about the vertical axis can also be limited while allowing the movement described above.

In accordance with yet a further aspect of the present invention, provided is a support structure that can be used with existing decoys or new decoys that provides the described advantages.

These and other aspects of the invention will be apparent to those skilled in the art in view of the following discussion and the appended claims.

### BRIEF DESCRIPTION OF THE DRAWINGS

The foregoing will in part be obvious and in part be pointed out more fully hereinafter in connection with a written description of preferred embodiments of the present invention illustrated in the accompanying drawings in which:

FIG. 1 is an elevation view of a decoy stake according to the invention;

FIG. 2 is an enlarged top view of a decoy mount according to another aspect of the present invention;

FIG. 3 is a side view of the decoy mount shown in FIG. 2;

FIG. 4 is an enlarged top view of yet another decoy mount according to yet another aspect of the present invention;

FIG. 5 is a side view of the decoy mount shown in FIG. 4;

FIG. 6 is an enlarged top view of a further decoy mount according to a further aspect of the present invention;

FIG. 7 is a side view of the decoy mount shown in FIG. 6;

FIG. 8 is an enlarged top view of yet even a further decoy mount according to another aspect of the present invention;

FIG. 9 is a side view of the decoy mount shown in FIG. 8;

FIG. 10 is an enlarged top view of another decoy mount according to another aspect of the present invention;

FIG. 11 is a side view of the decoy mount shown in FIG. 10;

FIG. 12 is an enlarged top view of yet another decoy mount according to another aspect of the present invention;

FIG. 13 is a side view of the decoy mount shown in FIG. 12; and,

FIG. 14 is a side view of a further decoy mount.

### DETAILED DESCRIPTION OF PREFERRED EMBODIMENTS

This application is hereby deemed to incorporate the entire disclosures of U.S. provisional and corresponding nonprovisional applications Ser. No. 60/609,144, filed Sep. 10, 2004, and Ser. No. 11/204,902, filed Aug. 15, 2005; and Ser. No. 60/625,319, filed Nov. 5, 2004, and Ser. No. 11/268,143, filed Nov. 7, 2005, as if fully set forth. More particularly, the structures of the decoys, stakes and included elements can be substituted for corresponding aspects in the embodiments of said incorporated disclosures, and vice versa, within scope of the inventions disclosed and claimed.

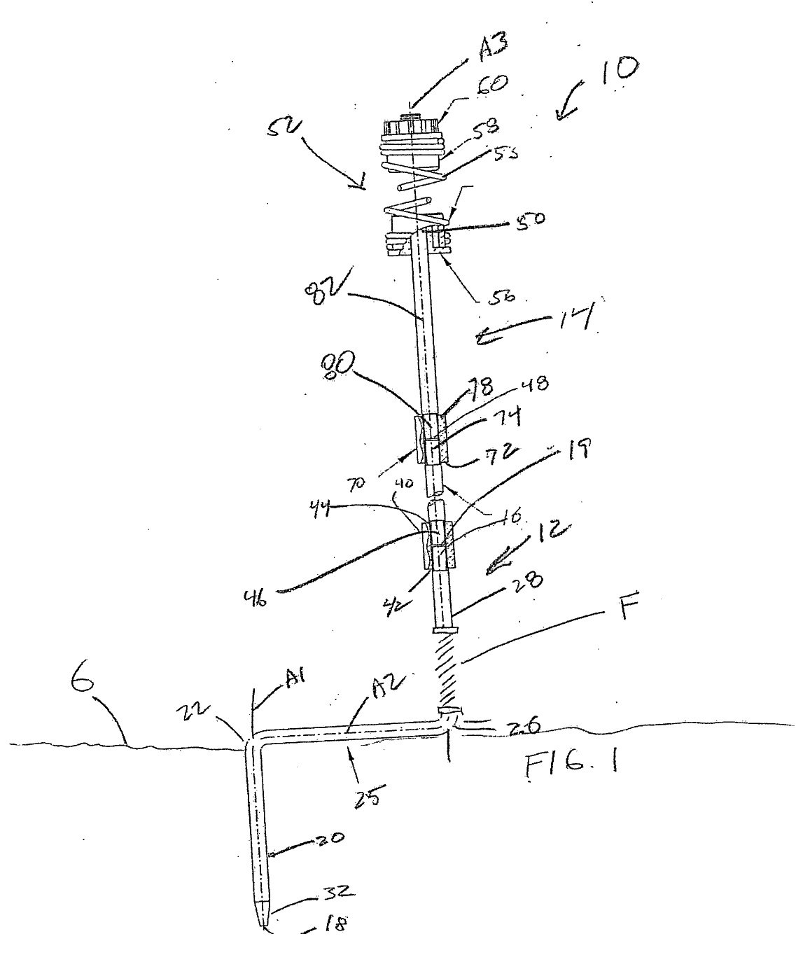

Referring now in greater detail to the drawings wherein the examples shown are for the purpose of illustrating preferred embodiments of the invention only, and not for the purpose of limiting the invention, FIG. 1 illustrates a hunting decoy stake 10 assembly according to an aspect of the invention.

Stake 10 includes a ground portion 12, a support portion 14, and one or more intermediate rods 16 extendable between portions 12 and 14. Ground portion 12 extends between a bottom end 18 and a top end 19 and includes a lower, generally vertical section 20 adjacent bottom end 18 that is coaxial to axis A1, a first ninety degree bend 22, a generally horizontal mid-section 25 coaxial to axis A2, a second ninety degree bend 26 and an upper section 28 adjacent top end 19 and which is coaxial to axis A3. Bottom end 18 can include a conical end portion 32 to help the stake enter the ground.

While it may be preferred to have ninety degree bends 22 and 26, it is not necessary. As can be appreciated, ninety degree bends create a generally horizontal mid-section 25 that can help allow the end user to use their foot to force the stake into the ground.

As can be appreciated, in another embodiment, bends 22 and 26 can be non-ninety degree angles and, for example, can be less than ninety degrees which also produces a mid-section that can be used to force the stake into the ground. Furthermore, this mid-section arrangement can also be used to allow the decoy to rotate about lower section 20 based upon the direction of the wind is the user maintains mid-section 25 above the ground.

Further, flexible member F, shown and described in connection with stake 10, can be included in any of the embodiments herein, the embodiments disclosed in U.S. U.S. Provisional Applications 60/609,144 and 60/625,319 and other stake configurations.

Flexible member F can be any flexible member known in the art including, but not limited to, a coil spring. Flexible member F allows for further motion in the decoy and can be used in connection with other motion devices known in the art and disclosed in U.S. Provisional Applications 60/609,144 and 60/625,319.

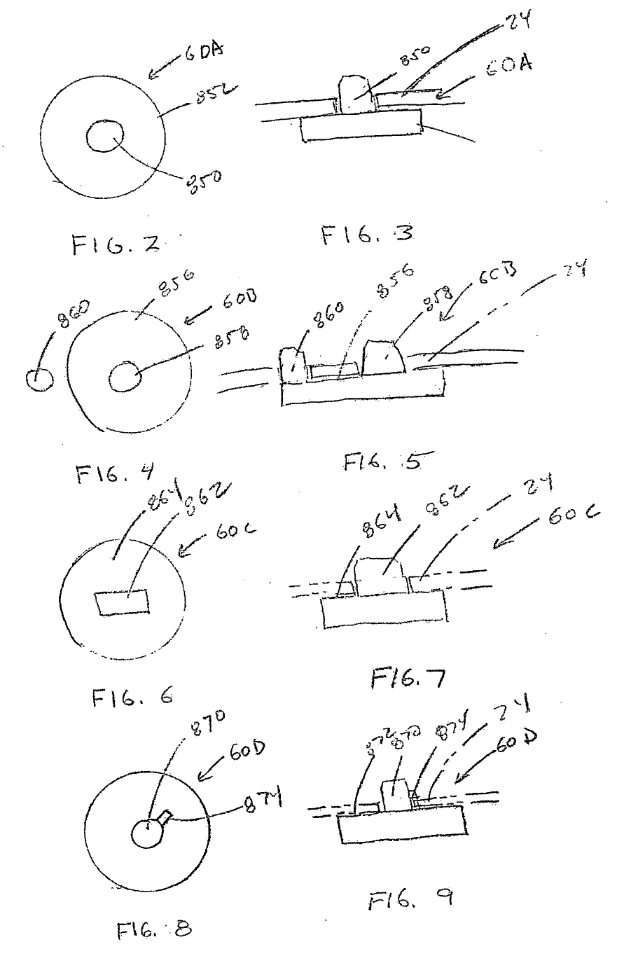

With reference to FIGS. 2-9, mount 60 can have many different configurations to produce a desired result. As discussed in U.S. Provisional Applications 60/609,144 and 60/625,319, the mount can include a threaded shaft 61 such that nut 62 can be tightened down to secure the decoy body to the stake.

However, as can be appreciated, it is also desirable to have a mount that does not require a separate fastener. As discussed in U.S. Provisional Applications 60/609,144 and 60/625,319, stake 10 can include and mount 60A that only includes an upwardly extending protrusion 850 and a generally flat base 852. As is discussed in greater detail, protrusion 850 can also be lengthened to further prevent inadvertent disengagement even in windy conditions. The hole in the decoy body in then merely placed over protrusion 850. Mounts 60B, 60C, and 60D could then also be lengthened to reduce the possibility of the decoy body disengaging the stake. By way of example, the protrusions can be approximately one-half inch in length.

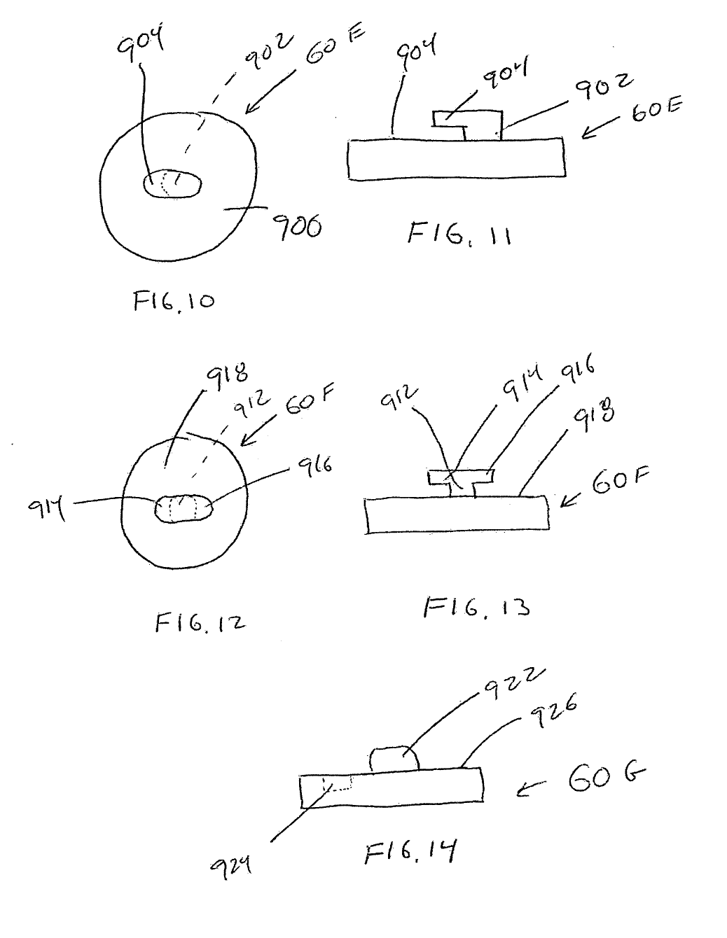

With reference to FIGS. 10-14, the mount can include any one of a number of locking flanges. In this respect, mount 60E includes a protrusion 902 with a locking flange 904. As can be appreciated, said flange can prevent the decoy body from moving upwardly relative to the stake and disengaging the stake.

Flange 904 can be spaced from base 906 such that the body can be tilted relative to the mount thereby allowing said flange to first pass through the mounting hole in the body. Then, the body can be articulated to align protrusion 902 with the decoy body hole to allow the protrusion to enter the hole and the body to rest on base 906.

Similarly, the decoy body can include an elongated opening such that the decoy body is rotated to allow the flange and protrusion to simultaneously enter the opening and then rotated again to lock the body to the mount.

Shown in FIGS. 12 and 13 is a mount 60F that includes a double flange arrangement. As can be appreciated, a number of flange configurations can be utilized to secure the body to the stake without the need for fasteners, including but not limited to, one or more of polygonally configured flanges and other “quarter turn” style flanges known in the art.

Mount 60F includes a protrusion 912 with flanges 914 and 916 that are spaced from a base 918. This is an example of a “quarter turn” arrangement wherein the decoy body includes an elongated opening that is positioned over the flanges and then the body is rotated relative to the stake such that the body is essentially locked between the flanges and the base. The flanges may also be rotatable between a locked condition and an unlocked condition.

The mount can optionally also include other fastening mechanisms such as a magnetic fastener, a magnetic assist fastener, or a hook-and-loop type fastener such as VELCRO™.

In this respect, mount 60G is shown in FIG. 14 as including an upward protrusion 922 and base 926 in addition to a magnet 924 that can be used in connection with a metal portion at or near the hole in the decoy body to prevent upward as well as rotational motion of the body relative to the stake.

As can be appreciated, the metal portion in the decoy body can be merely a reinforcement ring for the hole in the decoy body to prevent the tearing of the hole.

Furthermore, the metal portion can be a separate insert that is attached or affixed to the decoy body and used to align the body relative to the stake, which may provide an additional benefit in producing motions described in U.S. Provisional Applications 60/609,144 and 60/625,319.

The mount may also optionally include a locking detent or groove to assist in preventing the rotation of the body relative to the stake. The detent or groove can optionally work in connection with a spring washer or the like positioned between the flange and the base of the mount to force a pin or ridge into the detent or groove respectively.

In yet another embodiment, the protrusion or flange can be spring-loaded to create a downward force to create a locking engagement between the mount and the body of the decoy.

In yet even another embodiment, the hole in the decoy body may optionally include a mating impression or recess shaped to receive one or more flanges.

In yet even another embodiment, a portion of one or more flanges may optionally include a locking pin, ridge, detent, groove, or the like that matingly engages a portion of the decoy body hole to prevent rotation of the decoy relative to the stake.

While considerable emphasis has been placed on the preferred embodiment of the invention illustrated and described herein, it will be appreciated that other embodiments can be made and that many changes can be made in the preferred embodiment without departing from the principles of the invention. Accordingly, it is to be distinctly understood that the foregoing descriptive matter is to be interpreted merely as illustrative of the invention and not as a limitation.

What is claimed is:

1. A mounting mechanism for a decoy assembly comprising;
an elongated shaft for supporting a decoy body, wherein at least one portion along a length of the shaft comprises a laterally flexible element at which the shaft is free to flex such that a length of the shaft on one side of the laterally flexible element is diverted angularly from a rest position in response to an external force.

2. The mounting mechanism of claim 1, comprising at least two said laterally flexible elements spaced from one another along the shaft.

3. The mounting mechanism of claim 2, wherein one of said laterally flexible elements is adjacent to a base at a lower end and another of said laterally flexible elements is adjacent to a connection to the decoy body at an upper end.

4. The mounting mechanism of claim 1, further comprising at least one length extension section removably disposed between couplings to one of the base and a section of the shaft spaced above the laterally flexible element.

5. The mounting mechanism of claim 1, wherein the laterally flexible element comprises a coiled spring affixed between the length of the shaft that is diverted and a fixed base.

6. The mounting mechanism of claim 5, wherein the base includes a spike for penetrating a ground surface and further comprising a horizontal section attached to the spike, on which a user can step for inserting the spike.

7. A decoy assembly comprising a base and a connecting shaft between the base and a connection with a decoy body comprising at least one protrusion that is affixed relative to one of the base and the connecting shaft, wherein the protrusion protrudes through an opening of the decoy body that mates with the protrusion so as to limit movement of the decoy body relative to the protrusion.

8. The decoy assembly of claim 7, wherein the connection comprises at least one flange fixed relative to the protrusion, for supporting the decoy body at the opening that mates with the protrusion.

9. The decoy assembly of claim 8, further comprising a fastener selected from the group consisting of a magnetic fastener, magnetic assist fastener, and hook-and-loop fastener.

10. The decoy assembly of claim 7, wherein the opening rotationally engages the protrusion and the connection further comprises an eccentric detent affixing the decoy body at the connection.

11. The decoy assembly of claim 8, further comprising a spring mounted to urge a part of the connection against the decoy body adjacent to the opening.

12. The decoy assembly of claim 11, wherein the flange is integral with the protrusion.

13. The decoy assembly of claim 12, wherein the spring is placed between the flange and the base.

14. The decoy assembly of claim 7, wherein the connection comprises an element for limiting relative movement of the decoy body, selected from the group consisting of a locking pin, a ridge and detent, and a groove integral with the flange.

15. The decoy assembly of claim 7, wherein the connection comprises a rotational coupling between the shaft and the decoy body, and an eccentric element restricting a range of the rotational coupling.

16. The decoy assembly of claim 15, wherein the connection comprises at least one resilient spring member bearing axially at the connection for restricting the rotation.

17. The decoy assembly of claim 15, wherein the connection comprises a coil spring permitting angular flexing of the connection around at least one point between the decoy body and the base.

18. The decoy assembly of claim 15, wherein the connection permits angular flexing around at least two points between the decoy and the base.

19. The decoy assembly of claim 18, wherein at least one of said two points comprises a rotational connection comprising an element limiting rotational range.
